(19) United States
(12) Patent Application Publication
(10) Pub. No.: US 2003/0234918 A1
(43) Pub. Date: Dec. 25, 2003

(54) Adjustable soft mounts in kinematic lens mounting system

(75) Inventor: Douglas C. Watson, Campbell, CA (US)

Correspondence Address: BEYER WEAVER & THOMAS LLP, P.O. BOX 778, BERKELEY, CA, 94704-0778, US

(73) Assignee: Nikon Corporation, Tokyo (JP)

(21) Appl. No.: 10/446,882

(22) Filed: May 27, 2003

Related U.S. Application Data
(60) Provisional application No. 60/390,802, filed on Jun. 20, 2002.
(60) Provisional application No. 60/390,805, filed on Jun. 20, 2002.
(60) Provisional application No. 60/393,093, filed on Jul. 3, 2002.

(51) Int. Cl. G03B 27/42; G02B 7/02

(52) U.S. Cl. 355/53; 359/819

(57) ABSTRACT

A mounting system for mounting an optical element such as a deformable lens for use in a lithographic exposure process employs a plurality of adjustable soft mounts to support it and apply vector and moment forces at its peripheral portions so as to correct its shape. These adjustable soft mounts each have an elastic member such as a coil spring, a cantilever plate spring or a torsion spring and a force-adjusting member such as an adjusting screw or bolt that varies the force applied by the elastic member to a peripheral portion of the optical element. The soft mounts are significantly less rigid than position defining mounts that support the optical element at a desired position.

### BACKGROUND OF THE INVENTION

This invention relates to a kinematic mounting system for an optical element and in particular for a deformable refracting lens, as well as adjustable soft mounts to be used in such a mounting system.

Optical elements that are herein considered are those of optical systems having extremely high accuracy, precision and freedom from aberrations as well as the ability to make observations and exposures in ranges of wavelength outside the visible spectrum such as required in many manufacturing and scientific processes such as a lithographic exposure process.

For example, at least one lithographic exposure process is invariably required for establishing the location and basic dimensions of respective electrical or electronic elements in semiconductor integrated circuits in which the number of such elements on a single chip can be extremely large. The respective electrical or electronic elements can be very small and placement in close proximity at a high integration density is highly desirable in order to reduce signal propagation time and susceptibility to noise as well as to achieve other advantages such as increased functionality and, in some cases, manufacturing economy. These circumstances provide strong incentives to develop smaller minimum feature size regimes which must be established through lithographic exposures of a resist. Resolution and aberration of the exposure must therefore be held within a very closely defined budget, which is a small fraction of the minimum feature size.

The resolution of any optical system is a function of the wavelength of the energy used for the exposure although some arrangements such as phase-shift masks have allowed exposure resolution to be extended below the wavelength of the exposure radiation. Nevertheless, resolution of extremely small features requires correspondingly short wavelengths of radiation. Accordingly, use of X-rays for lithographic exposure is known but not widely used due to the requirement for fabrication of an exposure mask at the same minimum feature size as the final desired pattern since reduction of the size of the pattern cannot be achieved with X-rays. Optical and electron beam projection systems can achieve such image pattern reduction in the exposure pattern relative to feature sizes in a reticle which establishes the pattern to be exposed. Between these two techniques, however, reticles for electron beam projection are generally far more expensive than optical reticles and, perhaps more importantly, require many more exposures to form a complete integrated circuit pattern since the exposure field at the chip is comparatively more limited in electron beam projection systems. Thus, there is a substantial continued interest in optical lithographic exposure systems and extending their capabilities to shorter wavelengths, such as extreme ultraviolet (EUV).

EUV wavelengths are generally considered to be in the range of about 12 to 14 nanometers and more specifically within a range of less than one nanometer in a band centered on approximately 13 nanometers. At such wavelengths, most imaging materials which are transparent in the visible spectrum and which are suitable for lenses are substantially opaque to the imaging radiation. Thus, optical systems having only reflective elements have been developed. Such fully reflective systems are usually more complex than refractive or catadioptric lens systems since interference between illumination of the reticle and illumination of the target with the projected pattern must be avoided. This means that the number of elements may have to be increased and the freedom from aberrations maintained or well-corrected throughout the entire optical system. The maintenance of high manufacturing yield in the above-discussed exemplary environment thus requires not only high stability of the optical system but frequent measurement and adjustment to assure an adequately high level of optical performance of the system.

While techniques of measurement of wave-front aberrations are known and sufficient to accurately characterize the performance of optical systems and elements thereof, practical arrangements for conducting such measurements are difficult and complex. For example, measurements cannot be made on the optical axis or within the exposure/projection field during an exposure without interference with that exposure because shadows may be cast or otherwise a portion of the focal plane of the system may be occupied. Measurements performed between exposures cannot be regarded as measurement of optical performance during the exposure itself and do not directly characterize the lithographic image but are often the only practical solution at the current state of the art even through sources of error may be introduced. Optical performance generally degrades with increasing distance from the optical axis of the system and, as a practical matter, it is desirable to use as much of the field where sufficient precision, resolution and freedom from aberrations can be maintained for projection of the desired image.

Active optics are known but have not been widely used to date in semiconductor lithography applications. Active optics involve the ability to change the overall or local shape of optical elements, whether transparent optical lenses or reflective optical elements, to alter the optical properties of the element. John Hardy (in “Active Optics: A New Technology for the Control of Light,” IEEE, Vol. 60, No. 6 (1978), herein incorporated by reference) provides an overview of this technology. In particular, some general suggestions are made for provision of mechanical arrangements for achieving localized or generalized deformations of reflecting optical elements to achieve different optical effects such as compensating for atmospheric turbulence. Nevertheless, measurement to achieve any particular optical effect remains extremely complex and difficult as discussed therein and the deformation of optical elements is limited and difficult to control, particularly when it is considered that deformations can be comprised of multiple components which may be relatively difficult to distinguish and which may take many different forms which are difficult to characterize. For example, some relatively large components of deformation of an optical element may be caused by manufacturing variation and/or mounting arrangements while some relatively smaller and generally more localized components of deformation may be due to thermal effects including but not limited to irregular absorption of radiation in accordance with the projected pattern. In general, however, some of the larger error components are engendered by unintended application of forces to an optical element from the mounting arrangement for the optical element, particularly where the optical element is intended to be somewhat deformable to accommodate active or adaptive alteration of the shape of the optical element. These forces will also generally exhibit both static and time-varying components and can be very complex since each point at which the optical element is contacted by the mounting structure can apply forces with as many as six degrees of freedom (that is, vector forces along three mutually orthogonal axes and a torque (or a moment force) around each of these three axes) such that complex strains and deformations may propagate over substantial portions of the optical element, if not its entirety. While these forces and the number of locations at which they can occur can theoretically be minimized, the mounting points are of finite area and the forces which may be applied may result from many causes and with superposed effects such as differences in thermal expansion of different structures with unpredictably localized sources of heat.

While some arrangements are known for providing static and/or dynamic correction of the shape of a reflective optical element, they are generally only applicable to reflective optical elements and are limited by the spatial frequency at which they can be practically applied. These arrangements, while generally effective and usable with the present invention, also add to the structural complexity of the combination of the optical element and its mounting arrangement as well as the complexity of the forces which may be unpredictably generated. Any of these can give rise to significant aberrations in an optical element and the optical system in which it is employed.

Throughout herein, expression “vector force” will be used to indicate a force in the ordinary sense of the word, say, in the Newtonian mechanics, expression “moment force” will be used to indicate what is more commonly referred to as a torque or a force which provides a torque, and expression “forces” without specifying whether vector or moment forces will be used where both vector and moment forces are intended to be included.

### SUMMARY OF THE INVENTION

It is therefore an object of this invention to provide an improved kinematic optical mounting system for dynamically minimizing or compensating forces which may be applied to an optical element.

It is another object of this invention to provide adjustable soft mounts that may be used in such a kinematic optical mounting system to correct astigmatism and other higher-order non-rotationally symmetric distortions, being of a simple structure, inexpensive and easily retrofittable.

It is still another object of the invention to provide an optical element such as a deformable lens that is supported by such a mounting system.

It is still another object of the invention to provide a method of kinematically supporting an optical element such as a refracting lens with reduced clamping force.

It is still another object of this invention to provide a lithography system incorporating an optical system including such a kinematic optical mounting system and/or such a deformable optical element.

A mounting system embodying this invention for kinematically mounting an optical element such as a deformable refracting lens may be characterized as comprising a plurality of adjustable soft mounts each applying vector or moment forces on a peripheral portion such as a circumferential flange of the optical element so as to deformably adjust its shape wherein such applied forces are significantly less stiff than the stiffness of the position defining mount for defining the position of the peripheral portion of the optical element.

Such a system may be formed by positioning three axially rigid structures and three tangentially rigid structures so as to be equally spaced and equidistantly arranged about the periphery of the optical element. Each of the axially rigid structures is rigid in an axial direction of the optical element and applies at least one force in a selected direction other than the axial direction, and each of the tangentially rigid structures is rigid in a tangential direction of the optical element and applies at least one force in a selected direction other than the tangential direction, such that unwanted forces imposed on the optical element are compensated by the forces applied by the axially rigid structures and the tangentially rigid structures.

An adjustable soft mount of this invention for adjustably supporting an optical element may be characterized as comprising an elastic member that directly or indirectly contacts and applies a biasing force in a specified direction on a portion of the optical element and a force-adjusting member that contacts and controllably deforms the elastic member so as to adjustingly vary the biasing force. Another similar elastic member may be provided so as to directly or indirectly contact and to apply an opposite force on that elastic member. The elastic member may comprise a coil spring, a torsion spring or a cantilever plate spring, and the force-adjusting member may comprise an adjustment screw or bolt.

The invention also relates to an optical system which may be characterized as comprising a deformable optical element, three kinematic mounts each supporting a peripheral portion of it, and three moment-applying devices at each of these kinematic mounts for applying three different moments to the optical element. These three moments are preferably mutually orthogonal, such as around the radial, axial and tangential directions.

Mounting systems of this invention may be used in a metrology system such as one comprising not only a reticle serving as a source of exposure light to be projected on a target object of exposure such as a semiconductor wafer by means of an optical system including optical elements such as mirrors and lenses but also a metrology light source situated off-axis with respect to the reticle for emitting light (“aberration-detecting light”) with a wavelength which may be different from that of the exposure light, a sensor for receiving the light from the metrology light source and devices for altering shapes of the optical elements based on the light received by the sensor. Any or all of the optical elements of the optical system may be mounted according to this invention. Likewise, a lithographic exposure apparatus of this invention may be characterized as having any or all of optical elements in its optical system mounted in a mounting system embodying this invention as described above.

### BRIEF DESCRIPTION OF THE DRAWING

The invention, together with further objects and advantages thereof, may best be understood with reference to the following description taken in conjunction with the accompanying drawings in which:

FIG. 1 is a cross-sectional schematic view of a lithographic exposure apparatus incorporating a projection apparatus of this invention;

FIG. 2 is a process flow diagram illustrating an exemplary process by which semiconductor devices are fabricated by using the apparatus shown in FIG. 1 according to the present invention;

FIG. 3 is a flowchart of the wafer processing step shown in FIG. 2 in the case of fabricating semiconductor devices according to the present invention;

FIG. 4 is a sectional view of a lens as an example of optical element to be mounted in a kinematic mounting system embodying this invention;

FIG. 5 is a schematic diagonal view of a kinematic mounting system embodying the present invention with an optical element mounted therein;

FIG. 6 is a schematic perspective view of a mounting structure of the kinematic mounting system of FIG. 4;

FIG. 7 is a schematic sectional view of a soft mount embodying this invention;

FIGS. 8, 9 and 10 are schematic sectional views of other soft mounts embodying this invention;

FIG. 11 is a schematic view of a portion of a mounting structure embodying this invention;

FIGS. 12, 13 and 14 are schematic views of other mounting structures embodying this invention;

FIG. 15 is a schematic perspective view of a portion of a deformable lens that is supported by a supporting system embodying this invention;

FIG. 16 is a schematic sectional view of an example of ways in which a moment force may be applied by a supporting system as shown in FIG. 15; and

FIG. 17 is a schematic diagram of a catoptic lens system in which the invention may be used.

### DETAILED DESCRIPTION OF THE INVENTION

FIG. 4 shows a lens 10 as an example of the optical element adapted to be supported in a lens mounting system or held by soft mounts of the present invention to be described in detail below, preferably including a circumferential flange 12 formed on a peripheral edge 14 thereof. Such a flange is not required but is advantageous in increasing the useful optical surface of the lens 10 and in substantially reducing optical deformation of the edge of the lens 10 due to mechanical clamping force. Conventionally, the lens is often clamped or secured on a peripheral surface portion 16 thereof but this blocks the optical surface of the periphery of the lens and can deform the lens surface. Since the clamped lens surface is generally curved, furthermore, a clamp on a peripheral surface 16 can also impart a radial force on the lens, causing distortion. If the lens 10 is held and clamped on its circumferential flange 12, any deformation and distortion of the lens 10 and its optical path caused by the mechanical clamping can be minimized.

FIG. 5 shows a kinematic mounting system 200 embodying this invention supporting an optical element 210 such as a lens shown at 10 in FIG. 4, including a support structure 220. The details of the support structure 220 do not limit the scope of the invention except that it is expected to be sufficiently stiff or rigid to define the position of the optical element 210 where it is supported, as will be explained more in detail below. The optical element 210 is shown as having a circular shape with a circumferential flange 211 formed on a peripheral edge thereof. The flange 211 is not required but is advantageous in increasing the useful optical surface of the lens optical element 210 and in substantially reducing optical deformation of the edge of the optical element 210 due to mechanical clamping force.

Three mounting structures (or “axially rigid mounting structures”) 230 are provided at 120° intervals around the periphery of the optical element 210 (only one of them being shown in FIG. 5 for clarity of disclosure). Three similarly structured but differently oriented mounting structures (or “tangentially rigid mounting structures”) 240 are additionally provided around the periphery of the optical element 210 (only one of them being shown in FIG. 5 also for clarity of disclosure), each equidistantly positioned between a pair of the axially rigid mounting structures 230. Thus, the axially and tangentially rigid structures 230 and 240 are positioned alternately at 60° intervals around the periphery of the optical element 210.

The axially and tangentially rigid mounting structures 230 and 240 will be described next. Since they are comprised of like or equivalent components, those like or equivalent components are indicated by the same numerals and will not be repetitiously described.

As schematically shown, each axially rigid mounting structure 230 is essentially a combination of a clamping structure 250, depicted in FIG. 6 as being generally C-shaped, and a flexure device 260. A portion of the clamping structure 250 is fixed to a peripheral portion of the optical element 210, or its flange 211 if it is provided. The flexure device 260 is of a so-called pivot type and may be of a known structure in the form of a rectangular rigid prism or of a columnar shape defining an axis and having flexure points at both ends in the nature of hinges. The flexure device 260 is connected to the clamping structure 250 at one end through one of the flexure points and to a fixed structure such as the support structure 220 referenced above. The axis defined by the flexure device is in the direction of the optical axis of the optical element 210, which direction is herein referred to as the Z-direction or its axial direction. Thus, the aforementioned combination of the clamping structure 250 and the flexure device 260 may be said to be rigid in the Z-direction while flexible in all other directions. Let the forces (vector and moment forces) related to six degrees of freedom of rigid body motion be written as Fᵣ, Fₜ, F_{z}, Mᵣ, Mₜ and M_{z}, where F and M each represent a vector force and a moment force and subscripts r, t and z respectively indicate “radial”, “tangential” and “axial” (or the Z-direction). In terms of these symbols, it may be stated that the axially rigid mounting structure 230 provides a constraint in one direction (Z-direction) while allowing five degrees of freedom associated with forces Fᵣ, Fₜ, Mᵣ, Mₜ and M_{z}.

As also shown in FIG. 5 schematically, each of the tangentially rigid mounting structures 240 is also substantially a combination of a clamping structure 250 and a flexure device 260 but is different therefrom in that the flexure device 260, similarly structured and similarly connected to the clamping structure 250 and a support structure 220, has its axis oriented tangentially with respect to the optical element 210. Thus, each of the tangentially rigid mounting structures 240 provides a constraint in one direction (tangential direction associated with force Fₜ) while allowing five degrees of freedom associated with forces Fᵣ, F_{z}, Mᵣ, Mₜ and M_{z}. In other words, the six axially and tangentially rigid mounting structures 230 and 240, each allowing five degrees of freedom, can provide a total of thirty different and independent degrees of freedom for adjustment to compensate for forces imposed on the optical element 210, say, by non-ideal mounting structure formation, while serving also as position defining mounts for adjusting the position (rather than the shape) of the optical element 210.

The degree of freedom of motion provided by the mounting structures 230 and 240 allows vector and moment forces to be applied to the optical element 210 at different locations so as to counteract unintentional forces applied thereto through the lens mounting structures and also serves to decouple such unintended forces such that they can be individually compensated. If the mounting structure, possibly in combination with other influences such as localized heating, places a force on and thereby causes distortion of the optical element, a contrary and compensating force can be applied to neutralize it. Moreover, tangentially rigid mounting structures 240 can serve to isolate forces occurring at the axially rigid mounting structures 230 from each other along the periphery of the optical element. These compensating forces may be applied in many different ways, as will be explained below.

The invention also relates to adjustable soft mounts in kinematic lens mounting systems that may be incorporated in the mounting structures 230 and 240 described above. Such soft mounts may be designed to carry a constant fraction of the weight of an optical element such as a lens. For example, if the position of the optical element is determined by three constraint points and four such soft mounts are distributed equally spaced between each pair of the constraint points around the optical element, each soft mount may be expected to apply an upward force on the optical element equal to 1/12 of its weight.

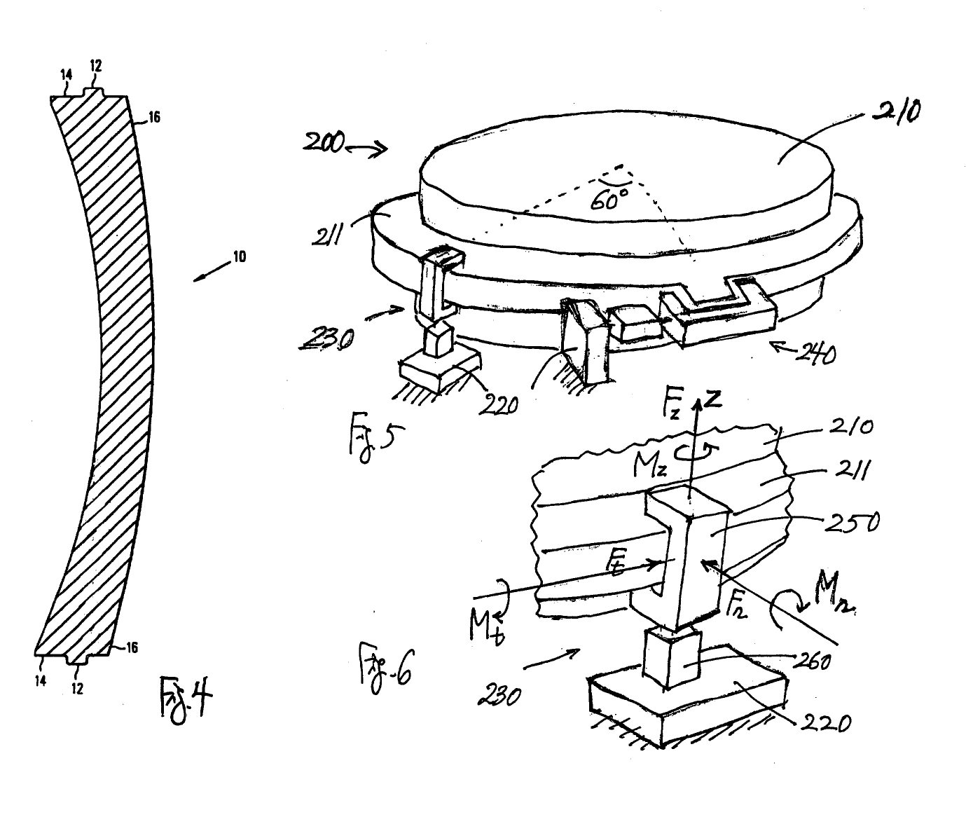

Soft mounts according to this invention are characterized as being adjustable, comprising a resilient member (which may generally be referred to as a spring) supporting directly or indirectly a peripheral point around an optical element (such as the circumferential flange 12 of the lens 10 shown in FIG. 4) and a device such as a screw for adjusting the elastic force of the spring. FIG. 7 shows a simple example of a soft mount embodying this invention comprising a low-stiffness plate spring 51 having one end fixed to a peripheral point of an optical element 210, or its flange 211, so as to apply an upward force thereonto. Throughout herein, whenever a soft mount or its component is said to be of low stiffness or less rigid, it is to be understood that the stiffness or rigidity is being compared with that of the position defining mounts for the optical element 210. The plate spring 51 is supported at a point in the middle 52 serving as its fulcrum and a screw 53 is provided so as to contact an opposite end portion of the plate spring 51 such that the upward force applied to the optical element 210 by the plate spring 51 can be kinematically adjusted by advancing and retracting the screw.

A downward force may be additionally applied to the optical element 210, as shown in FIG. 8, by providing another low-stiffness plate spring 55 contacting the optical element 210 from the opposite direction so as to apply a downward elastic force. FIG. 8 shows an embodiment wherein the downward-force-applying plate spring 55 is not provided with any adjusting means such as a screw as shown at 53, but both of the plate springs 51 and 55 may be made adjustable.

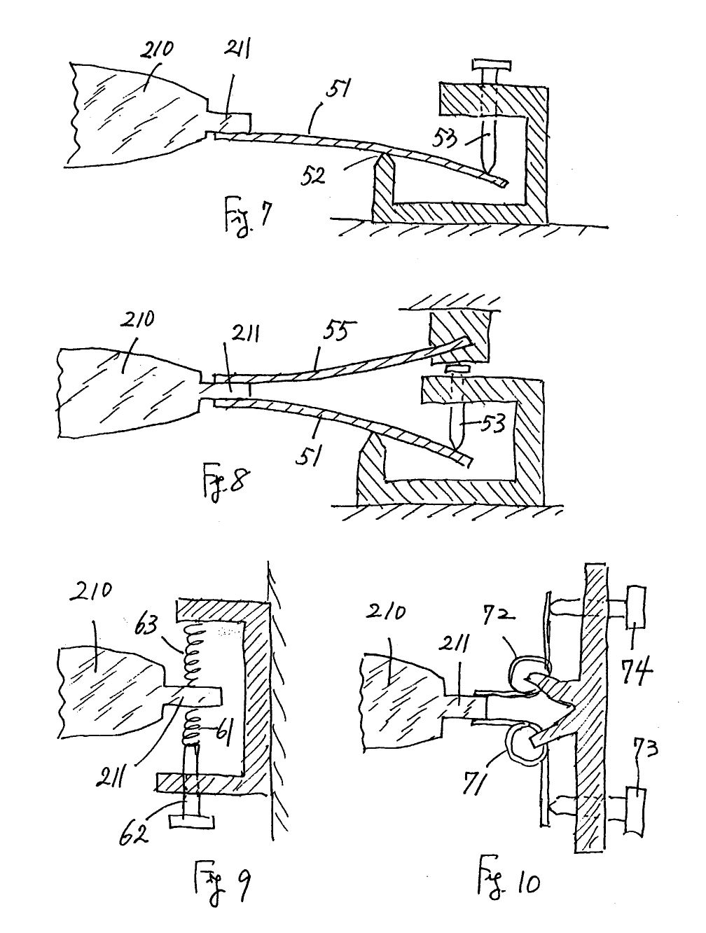

FIG. 9 is another embodiment of an adjustable soft mount embodying this invention comprising a low-stiffness coil spring 61 with one end fixed to a peripheral point of an optical element 210, or its flange 211, so as to apply an elastic force thereonto. The other end of the spring 61 is attached to an end of an adjustable screw 62, or a bolt, such that the elastic force of the spring 61 on the optical element 210 can be controlled by turning the screw 62. Another spring 63 may or may not be provided, with one end fixed to another point on the opposite surface of the optical element 210 so as to exert another elastic force thereon. The second coil spring 63 may be attached to another adjustable screw (not shown) like the screw 62 described above to make it also adjustable.

FIG. 10 is still another embodiment of an adjustable soft mount embodying this invention comprising torsion springs 71 and 72 as resilient members. One end of one of the torsion springs (71) and one end of the other of the torsion springs (72) are fixed to mutually oppositely facing surfaces of a peripheral portion of an optical element 210, or its flange 211, and adjustable screws 73 and 74 contact opposite end parts of the torsion springs 71 and 72, respectively, such that the clamping forces on the optical element 210 can be adjusted by rotating the screws 73 and 74.

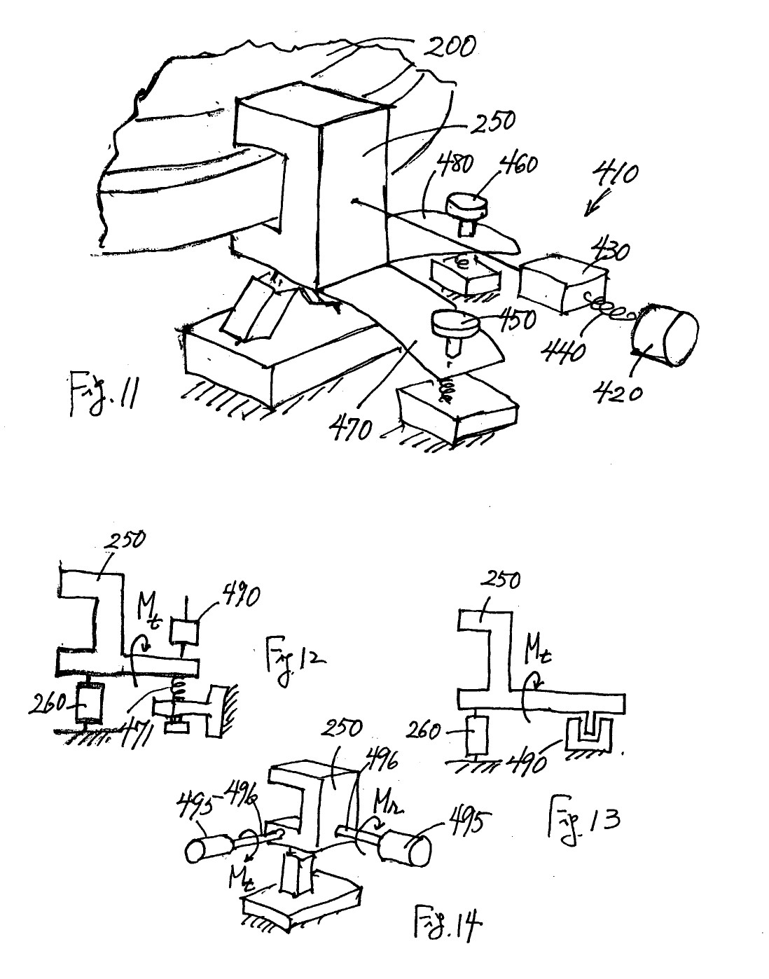

FIG. 11 shows schematically an example of a mounting structure constrained in the tangential and axial directions (or Fₜ and F_{z} directions). An actuator 410 comprised of a static adjustor 420, a soft spring 440 and a voice coil motor (VCM) 430 is provided to the clamping structure 250. A similar arrangement may be provided in the t and/or z directions as well if the C-shaped clamping structure is not constrained in the corresponding direction and allows a bias force to be applied by the static force adjustment and dynamic adjustment to be made by the VCM 430. The arrangement of FIG. 11 also minimizes power requirements for the VCM 430. Static moment forces Mᵣ and Mₜ can be applied in a similar manner as described above through off-axis mechanisms such as leaf springs 470 and 480 and adjustors 450 and 460. Dynamic adjustments can be added to these mechanisms as explained above.

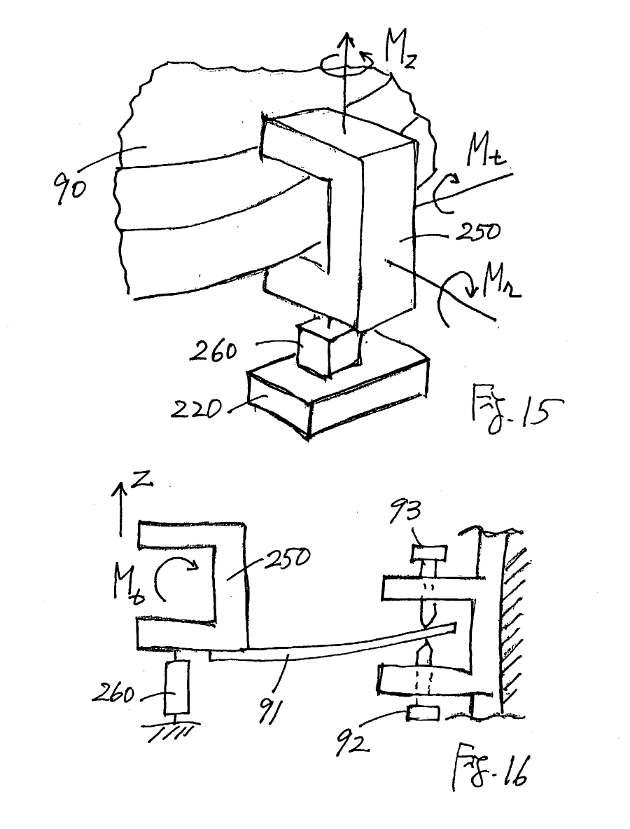

FIG. 12 shows schematically another example of a mounting structure for providing a static moment force Mₜ by means of a coil spring 471 and a VCM 490. FIG. 13 shows a variation, providing only a VCM 490 and adapted to provide static adjustments through a suitable DC component of the energization of the VCM 490. FIG. 14 represents an arrangement characterized as using torque motors 495 for applying moment forces Mᵣ and Mₜ through flexible coupling shafts 496.

It should be noted that tangential vector forces Fₜ are not desirable on the tangentially rigid mounting structures 240 and axial vector forces F_{z} are similarly not desirable on the axially rigid mounting structures 230 because they define the alignment positioning as well as the plane of the optical element 210 but axial vector forces F_{z} may be applied to the tangentially rigid mounting structures 240. It should also be noted that, in all these examples, the clamping mechanisms could be replaced by a simple adhesive bond between the fixture element and the lens.

In view of the above, it can be seen that the invention provides arrangements for developing compensating forces to avoid distortion of an optical element transmitted or engendered by mounting structures. As many as thirty degrees of freedom in adjustment can be provided to compensate for particular aberrations which may be detected. Appropriate compensating forces may be determined by modeling and inversion of the influence functions and corrections carried out on the basis of measured aberrations. The methodology of the correction preferably comprises the empirical development of influence functions of forces in each of the degrees of freedom provided by the above-described structure on aberrations of the optical element, inversion of the influence functions, mounting the optical element and making preliminary settings for each force in each degree of freedom, measurement of the surface of the optical element by interferometer, aberration metrology or the like and calculating and applying the calculated adjustments to optimize performance of the optical element and minimize aberrations.

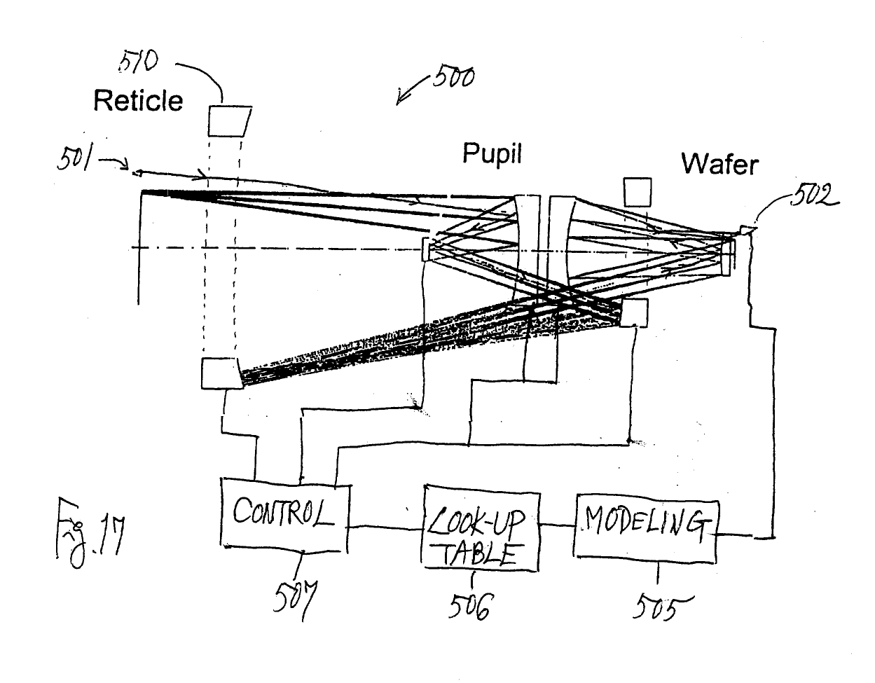

The present invention relates also to an optical element such as a deformable lens that is supported by such a mounting system. FIG. 15 schematically shows a deformable lens 90 with nine degrees of freedom as an example of such an optical element, being constrained in six degrees of freedom at three points (or “mounting points” of which only one point is shown). The constraint is preferably kinematic but this is not a requirement. The basic concept is that three moment forces are applied to the lens 90 through each of the three mounting points. The three moment forces being applied are preferably orthogonal such as Mᵣ, Mₜ and M_{z} about the radial, tangential and axial directions as schematically shown in FIG. 15) although these three moment forces need not necessarily be orthogonal.

These moment forces may be applied in many different ways. They may be applied passively or actively controlled. FIG. 16 shows an example of ways in which the moment force Mₜ around a tangential axis may be controllably applied to a clamping structure 250, having a soft cantilever blade spring 91 with one end attached to the bottom surface of the clamping structure 250, extending in the radial direction of the lens 90 and having an adjustment screw 92 contacting the other end of the blade spring 91. Another adjustment screw 93 may be optionally provided for providing an additional controlling force onto the blade spring 91, as shown in FIG. 16. FIG. 16 shows one moment force applied at one mounting point. The same technique may be applied about the radial and axial (Z-direction) axes and also at the other mounting points. Instead of the arrangement shown in FIG. 16, any of the examples shown in FIGS. 7-10 and 12-14 may be substituted.

Advantages of a deformable lens thus mounted include the ability to apply deforming moments to the lens to correct some aberrations in the shape. Moreover, no additional contact points are required, all deforming moment forces are applied at or near the lens perimeter such that the mounting arrangement is effective both for mirrors and refracting lenses. The arrangement is inexpensive and easy to implement, and it can correct for lens distortions caused by undesired moment forces from the mounting system.

FIG. 17 shows an exemplary catoptic lens system in which mounting systems according to this invention may be employed. All optical elements in this system are reflective and thus the lens system is suitable for projection of EUV (extreme ultraviolet) wavelengths or in any reflective element of any lens system. The illustrated optical system is suitable for image projection of a pattern established by a reticle onto a target such as a resist-coated wafer. It should be further noted that this optical system is relatively complex, including five mirrors and having a tortuous optical path among the elements. Some of these mirrors may be required to be annular or a segment of an annulus, and the system is principally off-axis which itself may give rise to significant aberrations.

In accordance with the invention, adaptive optics may be employed for any or all elements of the optical system of FIG. 17 or any similar system having reflector and/or lenses for its elements. It is necessary, however, to provide for measurement of any existing aberrations at least periodically such that corrective action can be taken to adjust the adaptive optic to reduce aberrations to an allowable level.

The metrology system 500 in accordance with the invention is installed as part of the projection lens. A metrology light source 501 for emitting aberration-detecting light, possibly with a wavelength different from the exposure wavelength (as is possible since no optical elements are refractive) is preferably situated slightly off-axis from the exposure light source, depicted as a location on a reticle 510. Because the metrology light source 501 is off-axis from the exposure light source and the target/wafer generally corresponds with the area of at least a portion of the reticle, the output metrology beam will be in a different location from the wafer being exposed. It is therefore possible to locate a metrology sensor 502 at the output location and to measure the aberration during exposure or without significant interruption of the exposure process. Accordingly, conditions of exposure may be fully or substantially maintained during measurement. It is also possible to sample a portion of the metrology output during changes or alignment and then splice the partial results together to create a map of the aberrations. Because the metrology is slightly off-axis, a model may be empirically derived, possibly by including interpolation and preferably in the form of a lookup table, to correlate the metrology results with actual performance and to make corrections appropriate to optimize performance.

It should be understood that the details of the metrology system are not important to the pratice of the invention. The discussion given above is provided only to demonstrate that relatively frequent measurement of aberrations during and between exposures to support dynamic correction as well as measurement of aberration on a less frequent basis for calibration, verification of adequate performance and the like are possible, even by using the same apparatus.

Once the aberrations of the system are determined from the aberrations detected by the off-axis or on-axis metrology system, for example, through means for modeling and inversion of the influence function 505, the appropriate corrections of the shape of any or all optical elements of the system may be determined, for example, from an empirically developed look-up table LUT 506. Corrections may then be passed to a control unit 507 to control suitable arrangements for altering the shape of the adaptive optical elements which may include arrangements for controlling specific regions of the optical element, particularly if reflective where force can be applied to the backside of the mirror as well as to the periphery of the optical element in accordance with the invention. The details of such control unit 507, however, are unimportant to the practice of the present invention.

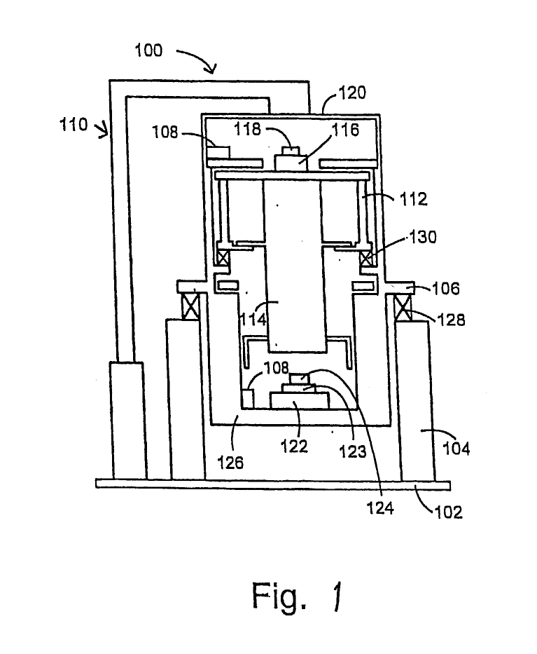

FIG. 1 shows a typical lithographic exposure apparatus 100 incorporating the mounting systems of this invention, comprising a mounting base 102, a support frame 104, a base frame 106, a measurement system 108, a control system (not shown), an illumination system 110, an optical frame 112, an optical device 114 which may include deformable optical elements mounted according to this invention, a reticle stage 116 for retaining a reticle 118, an upper enclosure 120 surrounding the reticle stage 116, a wafer stage 122, a wafer table 123 for retaining a semiconductor wafer workpiece 124, and a lower enclosure 126 surrounding the wafer stage 122.

The support frame 104 typically supports the base frame 106 above the mounting base 102 through a base vibration isolation system 128. The base frame 106 in turn supports, through an optical vibration isolation system 130, the optical frame 112, the measurement system 108, the reticle stage 116, the upper enclosure 120, the optical device 114, the wafer stage 122, the wafer table 123 and the lower enclosure 126 above the base frame 106. The optical frame 112 in turn supports the optical device 114 and the reticle stage 116 above the base frame 106 through the optical vibration isolation system 130. As a result, the optical frame 112, the components supported thereby and the base frame 106 are effectively attached in series through the base vibration isolation system 128 and the optical vibration isolation system 130 to the mounting base 102. The vibration isolation systems 128 and 130 are designed to damp and isolate vibrations between components of the exposure apparatus 100 and comprise a vibration damping device. The measurement system 108 monitors the positions of the stages 116 and 122 relative to a reference such as the optical device 114 and outputs position data to the control system. The optical device 114 typically includes a lens assembly that projects and/or focuses the light or beam from the illumination system 110 that passes through the reticle 118. The reticle stage 116 is attached to one or more movers (not shown) directed by the control system to precisely position the reticle 118 relative to the optical device 114. Similarly, the wafer stage 122 includes one or more movers (not shown) to precisely position the wafer workpiece 124 with the wafer table 123 relative to the optical device (lens assembly) 114.

As will be appreciated by those skilled in the art, there are a number of different types of photolithographic devices. For example, exposure apparatus 100 can be used as a scanning type photolithography system, which exposes the pattern from reticle 118 onto wafer 124 with reticle 118, and wafer 124 moving synchronously. In a scanning type lithographic device, reticle 118 is moved perpendicular to an optical axis of optical device 114 by reticle stage 116 and wafer 124 is moved perpendicular to an optical axis of optical device 114 by wafer stage 122. Scanning of reticle 118 and wafer 124 occurs while reticle 118 and wafer 124 are moving synchronously.

Alternatively, exposure apparatus 100 can be a step-and-repeat type photolithography system that exposes reticle 118 while reticle 118 and wafer 124 are stationary. In the step and repeat process, wafer 124 is in a constant position relative to reticle 118 and optical device 114 during the exposure of an individual field. Subsequently, between consecutive exposure steps, wafer 124 is consecutively moved by wafer stage 122 perpendicular to the optical axis of optical device 114 so that the next field of semiconductor wafer 124 is brought into position relative to optical device 114 and reticle 118 for exposure. Following this process, the images on reticle 118 are sequentially exposed onto the fields of wafer 124 so that the next field of semiconductor wafer 124 is brought into position relative to optical device 114 and reticle 118.

However, the use of exposure apparatus 100 provided herein is not limited to a photolithography system for a semiconductor manufacturing. Exposure apparatus 100, for example, can be used as an LCD photolithography system that exposes a liquid crystal display device pattern onto a rectangular glass plate or a photolithography system for manufacturing a thin film magnetic head. Further, the present invention can also be applied to a proximity photolithography system that exposes a mask pattern by closely locating a mask and a substrate without the use of a lens assembly. Additionally, the present invention provided herein can be used in other devices, including other semiconductor processing equipment, machine tools, metal cutting machines, and inspection machines. The present invention is desirable in machines where it is desirable to prevent the transmission of vibrations.

The illumination source (of illumination system 110) can be g-line (436 nm), i-line (365 nm), KrF excimer laser (248 nm), ArF excimer laser (193 nm) and F₂ laser (157 nm). Alternatively, the illumination source can also use charged particle beams such as x-ray and electron beam. For instance, in the case where an electron beam is used, thermionic emission type lanthanum hexaboride (LaB₆,) or tantalum (Ta) can be used as an electron gun. Furthermore, in the case where an electron beam is used, the structure could be such that either a mask is used or a pattern can be directly formed on a substrate without the use of a mask.

With respect to optical device 114, when far ultra-violet rays such as the excimer laser is used, glass materials such as quartz and fluorite that transmit far ultra-violet rays is preferably used. When the F₂ type laser or x-ray is used, optical device 114 should preferably be either catadioptric or refractive (a reticle should also preferably be a reflective type), and when an electron beam is used, electron optics should preferably comprise electron lenses and deflectors. The optical path for the electron beams should be in a vacuum.

Also, with an exposure device that employs vacuum ultra-violet radiation (VUV) of wavelength 200 nm or lower, use of the catadioptric type optical system can be considered. Examples of the catadioptric type of optical system include the disclosure Japan Patent Application Disclosure No. 8-171054 published in the Official Gazette for Laid-Open Patent Applications and its counterpart U.S. Pat. No. 5,668,672, as well as Japan Patent Application Disclosure No. 10-20195 and its counterpart U.S. Pat. No. 5,835,275. In these cases, the reflecting optical device can be a catadioptric optical system incorporating a beam splitter and concave mirror. Japan Patent Application Disclosure No. 8-334695 published in the Official Gazette for Laid-Open Patent Applications and its counterpart U.S. Pat. No. 5,689,377 as well as Japan Patent Application Disclosure No. 10-3039 and its counterpart U.S. Pat. No. 5,892,117 also use a reflecting-refracting type of optical system incorporating a concave mirror, etc., but without a beam splitter, and can also be employed with this invention. The disclosures in the above mentioned U.S. patents, as well as the Japan patent applications published in the Official Gazette for Laid-Open Patent Applications are incorporated herein by reference. Lorentz force or reactance force. Additionally, the stage could move along a guide, or it could be a guideless type stage which uses no guide. The disclosures in U.S. Pat. Nos. 5,623,853 and 5,528,118 are incorporated herein by reference.

Alternatively, one of the stages could be driven by a planar motor, which drives the stage by electromagnetic force generated by a magnet unit having two-dimensionally arranged magnets and an armature coil unit having two-dimensionally arranged coils in facing positions. With this type of driving system, either one of the magnet unit or the armature coil unit is connected to the stage and the other unit is mounted on the moving plane side of the stage.

Movement of the stages as described above generates reaction forces which can affect performance of the photolithography system. Reaction forces generated by the wafer (substrate) stage motion can be mechanically released to the floor (ground) by use of a frame member as described in U.S. Pat. No. 5,528,118 and published Japanese Patent Application Disclosure No. 8-166475. Additionally, reaction forces generated by the reticle (mask) stage motion can be mechanically released to the floor (ground) by use of a frame member as described in U.S. Pat. No. 5,874,820 and published Japanese Patent Application Disclosure No. 8-330224. The disclosures in U.S. Pat. Nos. 5,528,118 and 5,874,820 and Japanese Patent Application Disclosure No. 8-330224 are incorporated herein by reference.

As described above, a photolithography system according to the above described embodiments can be built by assembling various subsystems, including each element listed in the appended claims, in such a manner that prescribed mechanical accuracy, electrical accuracy and optical accuracy are maintained. In order to maintain the various accuracies, prior to and following assembly, every optical system is adjusted to achieve its optical accuracy. Similarly, every mechanical system and every electrical system are adjusted to achieve their respective mechanical and electrical accuracies. The process of assembling each subsystem into a photolithography system includes mechanical interfaces, electrical circuit wiring connections and air pressure plumbing connections between each subsystem. Needless to say, there is also a process where each subsystem is assembled prior to assembling a photolithography system from the various subsystems. Once a photolithography system is assembled using the various subsystems, total adjustment is performed to make sure that every accuracy is maintained in the complete photolithography system. Additionally, it is desirable to manufacture an exposure system in a clean room where the temperature and humidity are controlled.

Further, semiconductor devices can be fabricated using the above described systems, by the process shown generally in FIG. 2. In step 301 the device's function and performance characteristics are designed. Next, in step 302, a mask (reticle) having a pattern is designed according to the previous designing step, and in a parallel step 303, a wafer is made from a silicon material. The mask pattern designed in step 302 is exposed onto the wafer from step 303 in step 304 by a photolithography system such as the systems described above. In step 305 the semiconductor device is assembled (including the dicing process, bonding process and packaging process), then finally the device is inspected in step 306.

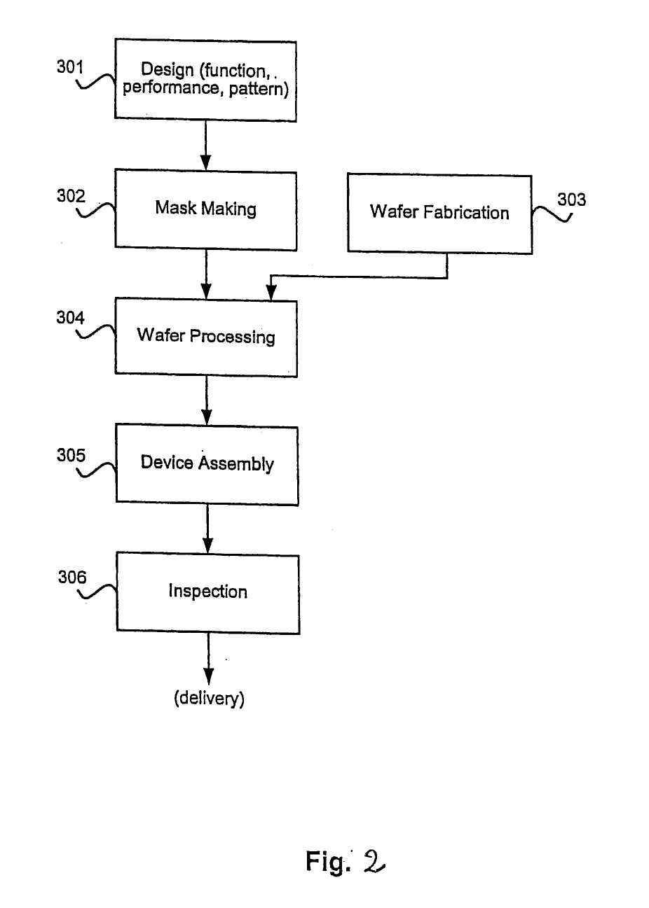

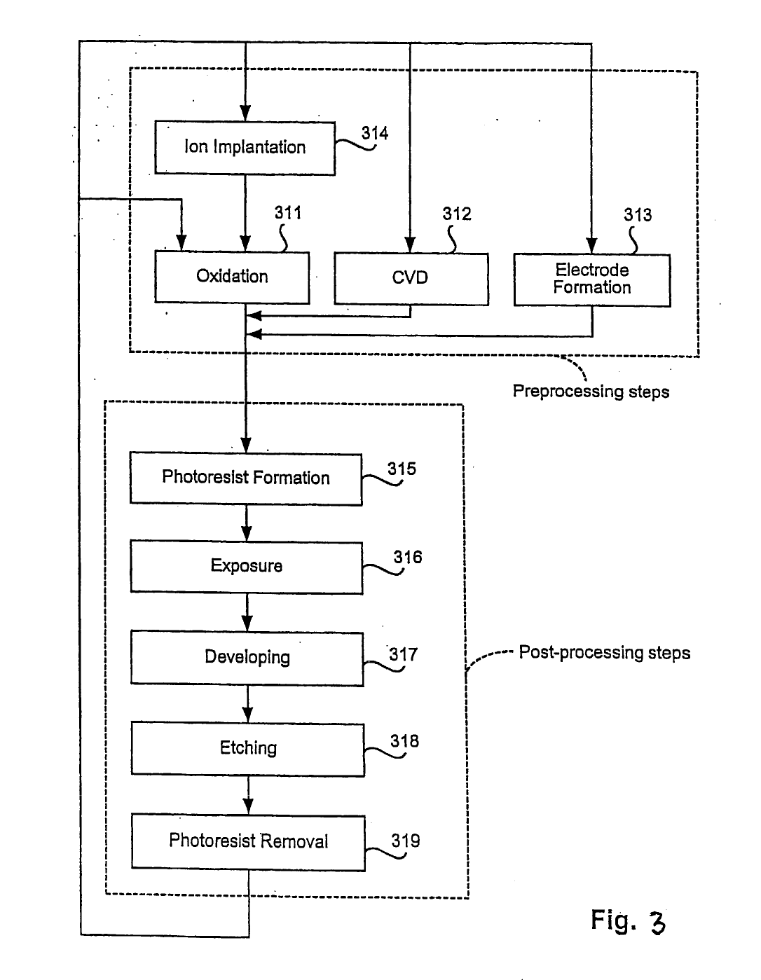

FIG. 3 illustrates a detailed flowchart example of the above-mentioned step 304 in the case of fabricating semiconductor devices. In step 311 (oxidation step), the wafer surface is oxidized. In step 312 (CVD step), an insulation film is formed on the wafer surface. In step 313 (electrode formation step), electrodes are formed on the wafer by vapor deposition. In step 314 (ion implantation step), ions are implanted in the wafer. The above mentioned steps 311-314 form the preprocessing steps for wafers during wafer processing, and selection is made at each step according to processing requirements.

At each stage of wafer processing, when the above-mentioned preprocessing steps have been completed, the following post-processing steps are implemented. During post-processing, initially, in step 315 (photoresist formation step), photoresist is applied to a wafer. Next, in step 316, (exposure step), the above-mentioned exposure device is used to transfer the circuit pattern of a mask (reticle) to a wafer. Then, in step 317 (developing step), the exposed wafer is developed, and in step 318 (etching step), parts other than residual photoresist (exposed material surface) are removed by etching. In step 319 (photoresist removal step), unnecessary photoresist remaining after etching is removed. Multiple circuit patterns are formed by repetition of these preprocessing and post-processing steps.

What is claimed is:

1. A mounting system for kinematically mounting an optical element, said mounting system comprising a plurality of adjustable soft mounts, each of said adjustable soft mounts applying shape-adjusting forces selected from the group consisting of vector forces and moment forces on a portion of said optical element and thereby deformably adjusting shape of said optical element and having a position defining mount for defining a position of said peripheral portion, said soft mounts being significantly less rigid than said position defining mount.

2. The mounting system of claim 1 wherein said portion is a peripheral portion of said optical element.

3. The mounting system of claim 1 wherein said plurality of adjustable soft mounts include axially rigid structures and tangentially rigid structures, each of said axially rigid structures being rigid in an axial direction of said optical element and applying at least one force in a selected direction other than said axial direction, each of said tangentially rigid structures being rigid in a tangential direction of said optical element and applying at least one force in a selected direction other than said tangential direction, whereby unwanted forces imposed on said optical element are compensated by the forces applied by the axially rigid structures and the tangentially rigid structures.

4. The mounting system of claim 2 wherein said plurality of adjustable soft mounts include axially rigid structures and tangentially rigid structures, each of said axially rigid structures being rigid in an axial direction of said optical element and applying at least one force in a selected direction other than said axial direction, each of said tangentially rigid structures being rigid in a tangential direction of said optical element and applying at least one force in a selected direction other than said tangential direction, whereby unwanted forces imposed on said optical element are compensated by the forces applied by the axially rigid structures and the tangentially rigid structures.

5. The mounting system of claim 3 wherein three of said axially rigid structures and three of said tangentially rigid structures are disposed alternately and equidistantly around said optical element.

6. The mounting system of claim 4 wherein three of said axially rigid structures and three of said tangentially rigid structures are disposed alternately and equidistantly around said optical element.

7. The mounting system of claim 1 wherein each of said adjustable soft mounts comprises an elastic member that directly or indirectly contacts and applies a biasing force in a specified direction on a portion of said optical element and a force-adjusting member that contacts and controllably deforms said elastic member so as to adjustingly vary said biasing force.

8. An adjustable soft mount for adjustably supporting an optical element, said soft mount comprising an elastic member that directly or indirectly contacts and applies a biasing force in a specified direction on a portion of said optical element and a force-adjusting member that contacts and controllably deforms said elastic member so as to adjustingly vary said biasing force.

9. The soft mount of claim 8 wherein said specified direction is upward, said soft mount further comprising an additional elastic member that directly or indirectly contacts and applies a downward biasing force on said elastic member.

10. The soft mount of claim 8 wherein said elastic member is a coil spring and said force-adjusting member comprises an adjustment screw.

11. The soft mount of claim 8 wherein said elastic member is a torsion spring and said force-adjusting member comprises an adjustment screw.

12. The soft mount of claim 8 wherein said elastic member is a cantilever plate spring and said force-adjusting member comprises an adjustment screw.

13. An assembly comprising:
a deformable optical element;
three kinematic mounts each supporting said optical element at a peripheral position of said optical element; and
three moment-applying devices at each of said kinematic mounts, applying three different moments to said optical element.

14. The assembly of claim 13 wherein said three different moments are mutually orthogonal.

15. The assembly of claim 13 wherein one of said three moments is around a radial axis of said optical element and another is around a tangent to the perimeter of said optical element.

17. The assembly of claim 13 wherein said moments are applied passively.

18. The assembly of claim 13 wherein said moments are actively controlled.

19. A method of mounting an optical element, said method comprising the steps of:
providing a position defining mount for defining a position of said optical element;
providing a plurality of soft mounts, each of said soft mounts supporting and applying a shape-adjusting force on a peripheral portion of said optical element, said soft mounts being significantly less rigid than said position defining mount; and
adjusting said shape-adjusting force of each of said soft mounts.

20. The method of claim 19 wherein said shape-adjusting force is selected from the group consisting of vector forces and moment forces.

21. A metrology system comprising:
a reticle serving as a source of exposure light having an optical axis;
an optical system including optical elements for projecting said exposure light on a target object of exposure;
a metrology light source situated off said optical axis with respect to said reticle for emitting aberration-detecting light;
a metrology sensor for receiving said aberration-detecting light;
devices for altering shapes of said optical elements based on the aberration-detecting light received by said metrology sensor;
wherein at least one of said optical elements is mounted in a mounting system, said mounting system comprising a plurality of adjustable soft mounts, each of said adjustable soft mounts applying shape-adjusting forces selected from the group consisting of vector forces and moment forces on a peripheral portion of said optical element and thereby deformably adjusting shape of said optical element and having a position defining mount for defining a position of said peripheral portion, said soft mounts being significantly less rigid than said position defining mount.

22. The metrology system of claim 21 wherein said exposure light and said aberration-detecting light have different wavelengths.

23. A lithography system for projecting a pattern on a wafer by a projection beam by preliminarily determining a surface profile of the wafer on a stage and subsequently introducing the stage with the wafer into the projection beam, said lithographic system comprising:
an illumination source;
an optical system including a mounting system that mounts an optical element kinematically;
a reticle stage arranged to retain a reticle;
a working stage arranged to retain a workpiece; and
an enclosure that surrounds at least a portion of the working stage, the enclosure having a sealing surface;
wherein said mounting system comprises a plurality of adjustable soft mounts, each of said adjustable soft mounts applying shape-adjusting forces selected from the group consisting of vector forces and moment forces on a peripheral portion of said optical element and thereby deformably adjusting shape of said optical element and having a position defining mount for defining a position of said peripheral portion, said soft mounts being significantly less rigid than said position defining mount.

24. An object manufactured with the lithography system of claim 23.

25. A wafer on which an image has been formed by the lithography system of claim 23.

26. A method for making an object using a lithography process, wherein the lithography process utilizes a lithography system as recited in claim 23.

27. A method for patterning a wafer using a lithography process, wherein the lithography process utilizes a lithography system as recited in claim 23.
